(19) United States
(12) Patent Application Publication
(10) Pub. No.: US 2021/0071030 A1
(43) Pub. Date: Mar. 11, 2021

(54) POLYURETHANE COATING COMPOSITION AND METHOD FOR PREPARING COATED PRODUCT

(71) Applicant: Origin Company, Limited, Saitama (JP)

(72) Inventor: Yasuaki MANO, Tokyo (JP)

(73) Assignee: Origin Company, Limited, Saitama (JP)

(21) Appl. No.: 16/644,836

(22) PCT Filed: Sep. 4, 2018
(86) PCT No.: PCT/JP2018/032764

§ 371 Date: Mar. 5, 2020

(30) Foreign Application Priority Data
Sep. 8, 2017 (JP) 2017-173193

(51) Int. Cl. C09D 175/06; C09D 7/65

(52) U.S. Cl. CPC C09D 175/06; C09D 7/65

(57) ABSTRACT

A polyurethane coating composition including: a polyol compound as a main agent; a polyisocyanate compound as a curing agent; and a quaternary ammonium salt composed of a tertiary amine compound and a weak acid.

### TECHNICAL FIELD

The present disclosure relates to a novel family of adenosine kinase inhibitors, and more particularly to the treatment of epileptic seizures using the adenosine kinase inhibitors.

The present invention relates to a polyurethane coating composition and a method for producing a coated product.

### CROSS-REFERENCE TO RELATED APPLICATIONS

Priority is claimed on Japanese Patent Application No. 2017-173193, filed on Sep. 8, 2017, the content of which is incorporated herein by reference.

### BACKGROUND

Two-pack polyurethane paints form strong coating films by urethane bonds generated through reaction between a polyol compound as a main component with a polyisocyanate compound as a curing agent. One example of advantages achieved by utilizing this reaction is that, generally, a pot life of about 4 to 5 hours can be secured after mixing the main agent, the curing agent and the solvent.

On the other hand, there is a problem that, since the reactivity after coating application is moderate, heat-drying at 80° C. for about 30 minutes is required, and a curing period of about 3 to 4 days is required to completely cure the coating film.

As a conventional technique to address this problem, an organotin catalyst is used in an amount of about 0.0005 to 0.005 parts by mass with respect to 100 parts by mass of a polyol compound as a main agent for improving the reactivity (for example, Patent Document 1: Japanese Unexamined Patent Application Publication No. 2007-186707).

### DISCLOSURE OF THE INVENTION

### Problems to be Solved by the Invention

However, the use of the organotin catalyst in an amount as described in Patent Document 1 cannot confer sufficient effects in lowering the temperature and shortening the time for the heat-drying process for curing the coating film (hereinafter also referred to as milder heat-drying conditions), and in shortening the curing period. On the other hand, when the amount of the organotin catalyst used is increased, the reactivity in the coating curing improves, which however raises a problem that the pot life is shortened.

When an organotin catalyst is used, the organotin catalyst usually remains in the coating. Many of the organotin catalysts are known to be toxic to living organisms, and there are concerns about the impact on the environment. The REACH (Registration, Evaluation, Authorization and Restriction of Chemicals) regulations generally prohibit supply to the public of mixtures and molded products or parts thereof containing a tin component in an amount exceeding 0.1% by mass in terms of tin. Therefore, there is restriction on increasing the amount of the organotin catalyst used.

The present invention has been made in view of the above circumstances, and the object of the present invention is to provide a polyurethane coating composition containing a catalyst free from the above problems. Specifically, the above catalyst replaces the organotin catalysts which are restricted to be used in a limited amount due to toxicity problems, environmental problems and REACH regulations, and the above catalyst has a high reactivity that allows for milder heat-drying conditions as well as shorter curing time, without affecting the pot life. Further, another object of the present invention is to provide a method for producing a coated product, including a step of forming a coating film using the polyurethane coating composition.

### Means to Solve the Problems

(1) A polyurethane coating composition including: a polyol compound as a main agent; a polyisocyanate compound as a curing agent; and a quaternary ammonium salt including a tertiary amine compound and a weak acid.

(2) The polyurethane coating composition according to (1), wherein the tertiary amine compound is an amidine compound.

(3) The polyurethane coating composition according to (1) or (2), wherein the tertiary amine compound is diazabicyclononene or diazabicycloundecene.

(4) The polyurethane coating composition according to any one of (1) to (3), wherein an amount of the quaternary ammonium salt is 2.5% by mass or less based on the total mass of the polyol compound as the main agent.

(5) The polyurethane coating composition according to any one of (1) to (4), wherein the weak acid is an aliphatic carboxylic acid or an aromatic compound having a phenolic hydroxyl group.

(6) The polyurethane coating composition according to any one of (1) to (5), wherein the weak acid is phenol or octanoic acid.

(7) The polyurethane coating composition according to any one of (1) to (6), wherein the polyol compound is at least one polyol compound selected from the group consisting of an acrylic polyol, a polycarbonate polyol, and a polyether polyol.

(8) The polyurethane coating composition according to any one of (1) to (7), wherein the polyol compound is an acrylic polyol.

(9) The polyurethane coating composition according to any one of (1) to (8), which further comprises a solvent.

(10) The polyurethane coating composition according to (9), wherein the solvent comprises a secondary alcohol.

(11) The polyurethane coating composition according to (10), wherein the solvent further comprises a solvent having a higher evaporation rate than the secondary alcohol.

(12) The polyurethane coating composition according to (10) or (11), wherein an equivalent ratio of a hydroxyl group in the polyol compound and an isocyanate group in the polyisocyanate compound (isocyanate group/hydroxyl group) is 1.1 or more and 3.0 or less.

(13) A method for producing a coated product, comprising forming a coating film on a surface of a product or a component part of a product using the polyurethane coating composition of any one of (1) to (12).

### Effect of the Invention

The present invention provides a polyurethane coating composition including a highly reactive catalyst that not only can replace organotin catalysts which are restricted to be used in a limited amount due to toxicity problems, environmental problems, and REACH regulations, but also allows for milder heat-drying conditions for curing of a coating and reduction of curing time without affecting the pot life. Further, the present invention also provides a method for producing a coated product, including forming a coating film using the polyurethane coating composition.

### DESCRIPTION OF THE EMBODIMENTS

Hereinbelow, preferable embodiments of the polyurethane coating composition of the present invention are described; however, the present invention is not limited to these embodiments.

The polyurethane coating composition of the present embodiment includes: a polyol compound as a main agent; a polyisocyanate compound as a curing agent; and a quaternary ammonium salt including a tertiary amine compound and a weak acid.

### Polyol Compound

The polyol compound is a compound (polyhydric alcohol) having two or more hydroxyl groups in one molecule. In the present embodiment, a urethane bond is generated by the reaction between the hydroxyl groups in the polyol compound and the isocyanate groups in the polyisocyanate compound to be described below.

Examples of the polyol compound include an acrylic polyol, hexamethylene glycol, cyclohexanedimethanol, neopentyl glycol, a polyether polyol, a polyester polyol, a polycarbonate polyol, a polybutadiene polyol, a polyolefin polyol, a polyester amide polyol, a polycaprolactone polyol, an epoxy polyol, an alkyd-modified polyol, a castor oil-modified polyol, a fluorine-containing polyol and the like. Among these, as the polyol compound in the present embodiment, an acrylic polyol, a polycarbonate polyol, and a polyether polyol are preferable, and an acrylic polyol is more preferable.

Any one of these polyol compounds may be used alone, or two or more thereof may be used in combination.

In the present embodiment, the amount of the polyol compound with respect to the total mass of the polyurethane coating composition is preferably 3 to 30% by mass, more preferably 5 to 20% by mass, and still more preferably 5 to 15% by mass.

### Acrylic Polyol

The method for obtaining the acrylic polyol is not particularly limited, and those synthesized by a conventionally known production method may be used, or commercially available products may be used. Examples of the conventionally known production method include a method of copolymerizing an acrylic monomer and a hydroxyl group-containing (meth)acrylic monomer.

In this specification, “(meth) acryl” means acryl or methacryl, and “(meth) acrylate” means an acrylate or a methacrylate.

Examples of the hydroxyl group-containing (meth)acrylic monomer include hydroxyalkyl (meth)acrylate. Examples of the hydroxyalkyl (meth)acrylate include 2-hydroxyethyl acrylate, 2-hydroxyethyl methacrylate, 4-hydroxybutyl acrylate, 1,4-cyclohexanediol monoacrylate, and the like.

The alkyl group of the hydroxyalkyl (meth)acrylate may be linear, branched or cyclic, preferably has 1 to 10 carbon atoms, and more preferably has 1 to 6 carbon atoms.

Any one of these hydroxyl group-containing (meth)acrylic monomers may be used alone, or two or more thereof may be used in combination.

Examples of the acrylic monomer include (meth)acrylic acid and (meth)acrylic acid alkyl ester. Examples of the (meth)acrylic acid alkyl ester include methyl (meth)acrylate, ethyl (meth)acrylate, n-propyl (meth)acrylate, isopropyl (meth)acrylate, and n-butyl (meth)acrylate, isobutyl (meth)acrylate, and the like.

Any one of these acrylic monomers may be used alone, or two or more of these acrylic monomers may be used in combination.

Any one of the acryl polyols obtained as described above may be used alone, or two or more may be used in combination.

Examples of the commercially available acryl polyol include OLESTER Q195-45, Q472, Q320, Q166, Q420, Q155, Q185, Q186, Q193, Q174, Q171, Q612, Q177, Q182, Q517, Q202, Q203, Q627, Q152, Q161-45, 748-5M, 749-17AE, and 748-16AE (each manufactured by Mitsui Chemicals Inc.); Hitaroid 2160X, 2400, 2401B, 2453, 2462A, 2467S, 2468, 2637, 2665, 2795, 2680, 3001, 3012X, 3083, 3083-70B, 3098L, 3204EB-1, 3509, 3368, 3375, 3379, 3387, 3704-2, 3534, 3546-3, 3511, 3624B, 3675, 3675B-57, 3901B, 3588, 3322A, 3458, 3618, 6500, 6500B, 6505, D1002, and D1004B (each manufactured by Hitachi Chemical Co., Ltd.); ACRYDIC A-801-P, A-817, A-837, A-848-RN, A-814, 57-773, A-829, 55-129, 49-394-IM, A-875-55, A-870, A-871, A-859-B, 52-666-BA, 52-668-BA, WZU-591, WXU-880, BL-616, CL-1000, and CL-408 (each manufactured by DIC Corporation); DIYANAL LR-237, LR-254, LR-257, LR-286, LR-1503, LR-1532, LR-1545, LR-1569, LR-1573, and LR-1589 (each manufactured by Mitsubishi Rayon Co., Ltd.).

The acrylic polyol preferably has a weight average molecular weight of 3,000 to 100,000, more preferably 5,000 to 60,000, and still more preferably 6,000 to 40,000.

When the weight average molecular weight of the acrylic polyol is not less than the above lower limit value, film formation is easy and sufficient curability can be obtained even in a short time. When the weight average molecular weight of the acrylic polyol is not more than the above upper limit value, the smoothness of the coating is enhanced and the effect of obtaining an excellent appearance is enhanced.

In the present specification, the “weight average molecular weight” indicates a value in terms of polystyrene to be measured according to a gel permeation chromatography (GPC) method.

The hydroxyl value of the acryl polyol is preferably 30 mgKOH/g or more and 150 mgKOH/g or less, more preferably 40 mgKOH/g or more and 100 mgKOH/g or less, and still more preferably 50 mgKOH/g or more and 80 mgKOH/g or less.

In another aspect of the present invention, the hydroxyl value of the acryl polyol is preferably 10 mgKOH/g or more and 150 mgKOH/g or less, more preferably 20 mgKOH/g or more and 100 mgKOH/g or less, and still more preferably 30 mgKOH/g or more and 80 mgKOH/g or less.

When the hydroxyl value of the acryl polyol is not less than the above lower limit value, a sufficient crosslinking density can be obtained, so that the effect of improving the curability of the coating film is enhanced. When the hydroxyl value of the acryl polyol is not more than the above upper limit value, the hydroxyl group concentration does not become too high, so that the urethanization reaction is suppressed, and as a result, the effect of suppressing the influence on pot life is enhanced.

The hydroxyl value is a parameter indicating the hydroxyl group content of a polyol compound, and is measured in terms of an amount of potassium hydroxide (mg relative to 1.0 g of a sample) required for neutralizing acetic acid required for acetylation of the hydroxyl groups in the sample. The hydroxyl value can be measured by a neutralization titration method stipulated in JIS0070-1992.

### Polycarbonate Polyol

The method for obtaining the polycarbonate polyol is not particularly limited, and those synthesized by a conventionally known production method may be used, or commercially available products may be used. Examples of the conventionally known production method include a method of subjecting a dialkyl carbonate and a diol to a transesterification reaction.

The dialkyl carbonate is preferably an aliphatic or alicyclic dialkyl carbonate having no aromatic ring, and examples thereof include dimethyl carbonate, diethyl carbonate, di-n-butyl carbonate, and ethylene carbonate.

Any one of these dialkyl carbonates may be used alone, or two or more thereof may be used in combination.

Examples of the diol include ethylene glycol, propylene glycol, 1,3-propanediol, 1,2-butanediol, 1,3-butanediol, 1,4-butanediol, 1,5-pentanediol, 3-methyl-1,5-pentanediol and 1,6-hexanediol.

Any one of these diols may be used alone, or two or more thereof may be used in combination.

Any one of the polycarbonate polyols obtained as described above may be used alone, or two or more may be used in combination.

Examples of the commercially available polycarbonate polyol include Plaxel; CD210, manufactured by Daicel Chemical Industries, Ltd.

The polycarbonate polyol can be appropriately selected depending on the purpose and the like. Specifically, the number average molecular weight thereof is 500 or more and 5000 or less, preferably 500 or more and 3500 or less, and more preferably 500 or more and 2000 or less.

When the number average molecular weight of the polycarbonate polyol is not less than the above lower limit, film formation is easy and sufficient curability can be obtained even in a short time. When the number average molecular weight of the polycarbonate polyol is not more than the above upper limit value, the polycarbonate polyol is obtainable as a liquid, so that workability is good.

In the present specification, the “number average molecular weight” indicates a value in terms of polystyrene to be measured according to a gel permeation chromatography (GPC) method.

The hydroxyl value of the polycarbonate polyol is preferably 50 mgKOH/g or more and 250 mgKOH/g or less, more preferably 80 mgKOH/g or more and 150 mgKOH/g or less, and still more preferably 100 mgKOH/g or more and 120 mgKOH/g or less.

When the hydroxyl value of the polycarbonate polyol is not less than the above lower limit value, a sufficient crosslinking density can be obtained, so that the effect of improving the curability of the coating film is enhanced. When the hydroxyl value of the polycarbonate polyol is not more than the above upper limit value, the hydroxyl group concentration does not become too high, so that the urethanization reaction is suppressed, and as a result, the effect of suppressing the influence on pot life is enhanced.

### Polyether Polyol

The method for obtaining the polyether polyol is not particularly limited, and those synthesized by a conventionally known production method may be used, or commercially available products may be used. Examples of the conventionally known production method include a method of reacting a compound having two active hydrogens with an alkylene oxide.

Examples of the compound having two active hydrogens include water, ethylene glycol, 1,2-propanediol, 1,3-propanediol, 1,4-butanediol and the like.

Any one of these compounds having two active hydrogens may be used alone, or two or more of them may be used in combination.

Examples of the alkylene oxide include ethylene oxide and propylene oxide.

Any one of these alkylene oxides may be used alone, or two or more thereof may be used in combination.

Any one of the polyether polyols obtained as described above may be used alone, or two or more may be used in combination.

Examples of the commercially available polyether polyol include Exenol; 100S, 450ED, and 750ED, manufactured by Asahi Glass Co., Ltd., and the like.

The polyether polyol can be appropriately selected depending on the purpose and the like. Specifically, the number average molecular weight thereof is 500 or more and 5000 or less, preferably 500 or more and 3500 or less, and more preferably 500 or more and 2000 or less.

When the number average molecular weight of the polyether polyol is not less than the above lower limit value, film formation is easy and sufficient curability can be obtained even in a short time. When the number average molecular weight of the polyether polyol is not more than the above upper limit value, the polyether polyol is obtainable as a liquid, so that workability is good.

The hydroxyl value of the polyether polyol is preferably 50 mgKOH/g or more and 250 mgKOH/g or less, more preferably 80 mgKOH/g or more and 150 mgKOH/g or less, and still more preferably 100 mgKOH/g or more and 120 mgKOH/g or less.

When the hydroxyl value of the polyether polyol is not less than the above lower limit value, a sufficient crosslinking density can be obtained, so that the effect of improving the curability of the coating film is enhanced. When the hydroxyl value of the polyether polyol is not more than the above upper limit value, the hydroxyl group concentration does not become too high, so that the urethanization reaction is suppressed, and as a result, the effect of suppressing the influence on pot life is enhanced.

### Polyisocyanate Compound

The polyisocyanate compound is a compound having two or more isocyanate groups in one molecule.

In the present embodiment, as for the isocyanate content in the polyurethane coating composition, the molar equivalent of the isocyanate group (—NCO) per 1 molar equivalent of the hydroxyl group contained in the polyol compound is preferably 0.5 to 2.0, more preferably 0.8 to 1.5, and still more preferably 1.0 to 1.2.

Examples of the polyisocyanate compound include aliphatic polyisocyanate compounds, alicyclic polyisocyanate compounds, aromatic polyisocyanate compounds, and araliphatic polyisocyanate compounds. Any one of these polyisocyanate compounds may be used alone, or two or more thereof may be used in combination.

Examples of the aliphatic polyisocyanate compound include trimethylene diisocyanate, tetramethylene diisocyanate, hexamethylene diisocyanate (also referred to as HDI), pentamethylene diisocyanate (also referred to as PDI), 1,2-propylene diisocyanate, 2,3-butylene diisocyanate, 1,3-butylene diisocyanate, dodecamethylene diisocyanate, 2,4,4-trimethylhexamethylene diisocyanate and the like. Any one of these aliphatic polyisocyanate compounds may be used alone, or two or more thereof may be used in combination.

Examples of the alicyclic polyisocyanate include 3-isocyanatomethyl-3,5,5-trimethylcyclohexyl isocyanate (isophorone diisocyanate, IPDI), 1,3-cyclopentane diisocyanate, 1,3-cyclohexane diisocyanate, 1,4-cyclohexane diisocyanate, methyl-2,4-cyclohexane diisocyanate, methyl-2,6-cyclohexane diisocyanate, 4,4′-methylenebis(cyclohexyl isocyanate) (hydrogenated MDI), 1,4-bis(isocyanatomethyl) cyclohexane, and the like. Any one of these alicyclic polyisocyanate compounds may be used alone, or two or more thereof may be used in combination.

Examples of the aromatic polyisocyanate include 1,3-phenylene diisocyanate, 4,4′-diphenyl diisocyanate, 1,4-phenylene diisocyanate, 4,4′-diphenylmethane diisocyanate, 2,4-tolylene diisocyanate, 2,6-tolylene diisocyanate, 4,4′-toluidine diisocyanate, 2,4,6-triisocyanate toluene, benzene-1,3,5-triisocyanate, dianisidine diisocyanate, 4,4′-diphenyl ether diisocyanate, 4,4′,4″-triphenylmethane triisocyanate, and the like. Any one of these aromatic polyisocyanate compounds may be used alone, or two or more thereof may be used in combination.

Examples of the araliphatic polyisocyanate include ω,ω′-diisocyanate-1,3-dimethylbenzene, ω,ω′-diisocyanate-1,4-dimethylbenzene, ω,ω′-diisocyanate-1,4-diethylbenzene, 1,4-tetramethylxylylene diisocyanate, 1,3-tetramethylxylylene diisocyanate, and the like.

Any of these araliphatic polyisocyanate compounds may be used alone, or two or more thereof may be used in combination.

The polyisocyanate may have any of a biuret structure, a nurate structure, an adduct structure, or an allophanate structure.

As the polyisocyanate, an aliphatic polyisocyanate and an alicyclic polyisocyanate are preferable in that the coating film is unlikely to be yellowed. Among them, a trimer of an aliphatic or alicyclic polyisocyanate having a biuret or nurate structure is more preferable, and an HDI having a biuret structure is particularly preferable. The isocyanate compound used may be commercially available products. Examples of the commercially available products include isocyanurate type polyisocyanates such as Coronate HX, Coronate HXLV, Coronate 2715, Coronate 2785 and Coronate HL, each manufactured by Tosoh Corporation, and Sumidur N-3300, manufactured by Sumika Bayer Urethane Co., Ltd.; and biuret type polyisocyanates such as Sumidur N-75, manufactured by Sumika Bayer Urethane Co., Ltd.

### Quaternary Ammonium Salt Composed of Tertiary Amine Compound and Weak Acid

The polyurethane coating composition of the present embodiment contains a quaternary ammonium salt composed of a tertiary amine compound and a weak acid. The quaternary ammonium salt is a catalyst that promotes a urethanization reaction between a hydroxyl group in the polyol compound and an isocyanate group in the polyisocyanate compound.

Hereinbelow, the tertiary amine compound and the weak acid in the present embodiment are described.

### Tertiary Amine Compound

The tertiary amine compound that constitutes the quaternary ammonium salt used in the present embodiment is a tertiary amine catalyst exhibiting strong basicity, which is usually used as a catalyst in the urethanization reaction.

Examples of the tertiary amine compound include diazabicycloundecene (1,8-diazabicyclo [5.4.0] undecene-7-ene, hereinafter also referred to as “DBU”), diazabicyclononene (1,5-diazabicyclo [4.3.0] nonen-5-ene, hereinafter also referred to as “DBN”), 1,4-diazabicyclo (3.3.0) oct-4-ene, 2-methyl-1,5-diazabicyclo (4.3.0) one-5-ene, 2,7,8-trimethyl-1,5-diazabicyclo (4.3.0) one-5-ene, 2-butyl-1,5-diazabicyclo (4.3.0) one-5-ene, 1,9-diazabicyclo (6.5.0) tridec-8-ene, N,N,N′,N′-tetramethylethylenediamine, N,N,N′,N′-tetramethylpropylenediamine, N,N,N′,N′,N″-pentamethyldiethylenetriamine, N,N,N′,N″,N″-pentamethyl-(3-aminopropyl) ethylenediamine, N,N,N′,N″,N″-pentamethyldipropylenetriamine, N,N,N′, N′-tetramethylguanidine, triethylenediamine, N,N,N′,N′-tetramethylhexamethylenediamine, N-methyl-N′-(2-dimethylaminoethyl) piperazine, N,N′-dimethylpiperazine, dimethylcyclohexylamine, N-methylmorpholine, N-ethylmorpholine, bis(2-dimethylaminoethyl) ether, 1-methylimidazole, 1,2-dimethylimidazole, 1-isobutyl-2-methylimidazole, and 1-dimethylaminopropylimidazole. Any one of these tertiary amine compounds may be used alone, or two or more thereof may be used in combination.

Among these tertiary amine compounds, amidine compounds are preferably used. Amidine compounds are generally known to exhibit strong basicity.

The amidine compound is a compound represented by the following formula (1).

R¹—C(═NR²)—NR³R⁴ (1)

wherein R¹ represents a hydrogen atom or an unsubstituted or substituted hydrocarbon group having 1 to 10 carbon atoms, and R², R³ and R⁴ each independently represent a unsubstituted or substituted hydrocarbon group having 1 to 10 carbon atoms.

In the formula (1), it is preferable that R² and R³ or R² and R⁴ are chemically bonded to each other. When R² and R³ are chemically bonded, it is preferable that R¹ and R⁴ are also chemically bonded. When R² and R⁴ are chemically bonded, it is preferable that R¹ and R³ are also chemically bonded.

The amidine compound is preferably one having a structure in which R² and R³ or R² and R⁴ are chemically bonded to form a 4- to 8-membered ring including the two nitrogen atoms in the formula (1), and R¹ and R⁴ or R¹ and R³ are chemically bonded to form a 4- to 10-membered ring including one of the nitrogen atoms in the formula (1).

Examples of the amidine compound having such a structure include diazabicycloundecene, diazabicyclononene, 1,4-diazabicyclo(3.3.0)oct-4-ene, 2-methyl-1,5-diazabicyclo(4.3.0)one-5-ene, 2,7,8-trimethyl-1,5-diazabicyclo(4.3.0)one-5-ene, 2-butyl-1,5-diazabicyclo(4.3.0)one-5-ene, and 1,9-diazabicyclo(6.5.0)tridec-8-ene, of which diazabicycloundecene and diazabicyclononene are more preferable because of their availability.

### Weak Acid

As described above, since the tertiary amine compound has a strong basicity, the use thereof as a catalyst in the urethanization reaction would make it difficult to secure a sufficient pot life due to excessively high activity thereof. Further, in this case, the coating curing reaction proceeds rapidly immediately after coating, thereby causing a problem that the polyurethane coating composition does not spread well and the smoothness of the coating film is deteriorated, resulting in inferior appearance of the coating film.

The weak acid that constitutes the quaternary ammonium salt used in the present embodiment appropriately blocks the basicity of the tertiary amine compound, but realizes a basicity with optimal activity that does not shorten the pot life, while sufficiently maintaining reactivity necessary for curing the coating film.

In the present specification, the term “weak acid” means an acid having an acid dissociation constant pKa of 2 or more. In the present specification, the acid dissociation constant pKa means an acid dissociation constant of an acidic group that first dissociates in the case of an acid having two or more acidic groups, such as dicarboxylic acid. Also, the information on the acid dissociation constants is easily available from literatures such as “Chemical Handbook Basic Edition II” (5th revision, edited by The Chemical Society of Japan, published by Maruzen Co., Ltd., 11-340-342), and “Organic Compound Encyclopedia” (edited by The Society of Synthetic Organic Chemistry, Japan, published by Kodansha Ltd.). When the information on the acid dissociation constants is not available from the literatures, the pKa can be measured by a conventionally known method. In the case of an acid soluble in water, the measurement is implemented in water, and in the case of an acid insoluble in water, the measurement is implemented in dimethyl sulfoxide or acetonitrile. In one example of the conventionally known method, the measurement is implemented by a method described in “Solution Equilibria”, F R Hartley, C. Burgess, and R M Alcock, John Wilery (1980) using a commercially available pH meter (for example, F-23, manufactured by Horiba, Ltd., temperature: 25° C.).

Examples of the weak acid constituting the quaternary ammonium salt in the present embodiment include carbonic acid, aliphatic carboxylic acids, aliphatic unsaturated dicarboxylic acids, aromatic carboxylic acids, aromatic compounds having a phenolic hydroxyl group, and the like. Any one of these weak acids may be used alone, or two or more may be used in combination.

Examples of the aliphatic carboxylic acid include formic acid, methanoic acid, propanoic acid, butanoic acid, pentanoic acid, hexanoic acid, heptanoic acid, octanoic acid, nonanoic acid, decanoic acid, undecanoic acid, dodecanoic acid, 2-ethylhexanoic acid, succinic acid, glutaric acid, adipic acid, pimelic acid, suberic acid, azelaic acid, sebacic acid, undecanedioic acid, decanedicarboxylic acid, 1,11-undecadicarboxylic acid, 1,12-dodecanedicarboxylic acid, hexadecanedioic acid, oxalic acid, malonic acid and the like. Any one of these aliphatic carboxylic acids may be used alone, or two or more thereof may be used in combination.

Examples of the aliphatic unsaturated carboxylic acid include acrylic acid, crotonic acid, vinyl acetate, methacrylic acid, tiglic acid, isocrotonic acid, propiolic acid, angelic acid, isanic acid, undecylenic acid, elaidic acid, erucic acid, behenolic acid, brassidic acid, propiolic acid, petroselinic acid, oleic acid, ricinelaidic acid, ricinoleic acid, 2-chloroacrylic acid, 3-chloroacrylic acid, 2-amino-3-butenoic acid, and 2-amino-3-hydroxy-4-hexynoic acid (acetoacetic acid). Any one of these aliphatic unsaturated carboxylic acids may be used alone, or two or more thereof may be used in combination.

Examples of the aromatic carboxylic acid include benzoic acid, trimellitic acid, pyromellitic acid, 2-hydroxyisophthalic acid, 4-hydroxyisophthalic acid, 5-hydroxyisophthalic acid, 2,3-dihydroxybenzoic acid, 2,4-dihydroxybenzoic acid, 2,5-dihydroxybenzoic acid, 2,6-dihydroxybenzoic acid, 3,4-dihydroxybenzoic acid, 3,5-dihydroxybenzoic acid and the like. Any one of these aromatic carboxylic acids may be used alone, or two or more thereof may be used in combination.

Examples of the aromatic compound having a phenolic hydroxyl group include phenol, trimethylphenol, o-aminophenol, p-octylphenol, o-cresol, m-cresol, p-cresol and the like. Any one of these aromatic compounds having a phenolic hydroxyl group may be used alone, or two or more thereof may be used in combination.

Among the above weak acids, it is preferable to use an aliphatic carboxylic acid or an aromatic compound having a phenolic hydroxyl group for the ease of preparation of the quaternary ammonium salt and the reasons described later. As the aliphatic carboxylic acid, it is more preferable to use octanoic acid. As the aromatic compound having a phenolic hydroxyl group, it is more preferable to use phenol.

By the use of octanoic acid or phenol, the quaternary ammonium salt has a basicity with an optimum activity that does not shorten the pot life, while maintaining sufficient reactivity necessary for curing the coating film.

As for the quaternary ammonium salt composed of the tertiary amine compound and the weak acid obtained as described above, any one kind thereof may be used alone, or two or more kinds thereof may be used in combination.

Examples of the commercially available product of the salt of diazabicycloundecene and octanoic acid include U-CAT SA102, manufactured by San-Apro Ltd. Examples of the commercially available product of the salt of diazabicycloundecene and phenol include U-CAT SA1, manufactured by San-Apro Ltd. Examples of the commercially available product of the salt of diazabicyclononene and octanoic acid include U-CAT1102, manufactured by San-Apro Ltd.

The amount of the quaternary ammonium salt composed of the tertiary amine compound and the weak acid is preferably 3.0% by mass or less, more preferably 2.5% by mass or less, still more preferably 2.3% by mass or less, and particularly preferably 2.1% by mass or less, with respect to the total mass of the polyol compound.

The amount of the quaternary ammonium salt composed of the tertiary amine compound and the weak acid is preferably 0.2% by mass or more and 3.0% by mass or less, more preferably 0.4% by mass or more and 2.5% by mass or less, still more preferably 0.6% by mass or more and 2.3% by mass or less, and particularly preferably 0.8% by mass or more and 2.1% by mass or less, with respect to the total mass of the polyol compound.

When the amount of the quaternary ammonium salt with respect to the total mass of the polyol compound is not less than the above lower limit value, sufficient activity necessary for curing the coating film is obtained, and milder heat-drying conditions and shorter curing period are possible, so that workability improves. When the amount of the quaternary ammonium salt with respect to the total mass of the polyol compound is not more than the above upper limit value, the residual quaternary ammonium salt, which is a liquid, in the coating film is suppressed, and the coating film obtained has a sufficient hardness.

### Solvent

The polyurethane coating composition of the present embodiment may further include a solvent. The presence of the solvent allows adjustment of the viscosity of the polyurethane coating composition to fall within a desired range, even when a polyol compound having a high weight average molecular weight is used.

Examples of the solvent include ketones such as diethyl ketone (3-pentanone), methyl propyl ketone (2-pentanone), acetylacetone, methyl isobutyl ketone (4-methyl-2-pentanone), 2-hexanone, 5-methyl-2-hexanone, 2-heptanone, 3-heptanone, 4-heptanone, cyclopentanone, cyclohexanone, and diacetone alcohol; esters such as ethyl acetate, isopropyl acetate, n-butyl acetate, isobutyl acetate, 3-methoxybutyl acetate, methyl propionate, ethyl propionate, diethyl carbonate, y-butyrolactone, isophorone, butyl isobutyrate, and propylene glycol monomethyl ether acetate; hydrocarbons such as heptane, hexane, and cyclohexane; aromatic hydrocarbons such as toluene, and xylene; glycol ethers such as butyl glycol, methyl diglycol, ethyl diglycol, butyl diglycol, 1-methoxy-2-propanol, and tetrahydrofuran; and naphtha. An aqueous medium may be used to further reduce the environmental load. The aqueous medium means a hydrophilic organic solvent. Examples of the hydrophilic organic solvent include alcohols such as methanol, ethanol, n-propanol, isopropanol, n-butanol, 2-butanol, isobutanol, 1-ethyl-1-propanol, 2-methyl-1-butanol, 4-methyl-2-pentanol, n-hexanol, and cyclohexanol; alcohols having an ether bond such as ethylene glycol monomethyl ether, ethylene glycol monoethyl ether, ethylene glycol monopropyl ether, ethylene glycol monobutyl ether, and propylene glycol n-propyl ether; ethers such as tetrahydrofuran, and 1,4-dioxane; ketones such as acetone, and methyl ethyl ketone; esters such as methyl acetate, n-propyl acetate, isopropyl acetate, methyl propionate, ethyl propionate, and dimethyl carbonate. Any one of these solvents may be used alone, or two or more of these solvents may be used in combination.

The use of the quaternary ammonium salt composed of the tertiary amine compound and the weak acid according to the present embodiment as a catalyst enables the curing of the coating film to be implemented with milder heat-drying conditions and shorter curing period, which, however, may raise a problem that the solvent remains in the coating film without being completely evaporated. The residual solvent in the coating film results in insufficient hardness of the coating film and inferior resistance of migration of the coating to the packaging material or the like in the initial stage after coating (hereinafter also referred to simply as “migration resistance”). Therefore, it is preferable to use a solvent having a high evaporation rate among the above solvents.

The evaporation rate of each solvent can be expressed in terms of the relative evaporation rate.

The relative evaporation rate is an evaporation rate based on n-butyl acetate, measured according to ASTM D3539-87 (2004). Specifically, the relative evaporation rate is a relative value of the evaporation rate based on the time required for 90% by mass of n-butyl acetate to evaporate in dry air (the higher the value, the higher the evaporation rate).

Specific examples of the relative evaporation rates of the solvents are shown in Table 1.

TABLE 1

| Solvent | Relative evaporation rate |
|---|---|
| n-butyl acetate (BAC) | 100 |
| 1-methoxy-2-propanol (PGM) | 66 |
| 5-methyl-2-hexanone (MIAK) | 50 |
| Toluene | 240 |
| 4-methyl-2-pentanol (MIBC) | 33 |
| 2-propanol (IPA) | 300 |
| 2-butanol | 89 |
| Propylene glycol n-propyl ether (PnP) | 21 |
| Methyl ethyl ketone (MEK) | 572 |
| Ethyl acetate (EAC) | 615 |

When the solvent has a hydroxyl group, the hydroxyl group may react with an isocyanate group in the polyisocyanate compound, thereby allowing the solvent having the hydroxyl group to be incorporated into the coating. This reaction is likely to occur particularly when the solvent evaporates and the concentrations of the polyisocyanate compound and the catalyst in the coating film are raised. When the hydroxyl group in the solvent reacts with the isocyanate group in the polyisocyanate compound and is incorporated into the coating film, the residual amount of the solvent in the coating film can be efficiently reduced, whereby the hardness of the coating film and the migration resistance are improved.

For example, when a solvent containing a secondary alcohol is used, the secondary alcohol hardly reacts with the polyisocyanate compound in the polyurethane coating composition. However, as described above, when the solvent evaporates in the course of curing the coating film to increase the concentrations of the isocyanate compound and the catalyst, a small amount of the secondary alcohol remaining without being evaporated in the course of curing the coating film reacts with the polyisocyanate compound and is taken into the coating film through urethane bonds. On the other hand, when a solvent containing a primary alcohol having a higher reactivity than the secondary alcohol is used, the primary alcohol is excessively taken into the coating film due to its excessively high reactivity, thereby causing a problem that the hardness of the coating film decreases. In the case of a tertiary alcohol, which is less reactive than the secondary alcohol, the tertiary alcohol hardly reacts with the polyisocyanate compound even under the conditions described above, and therefore remains in the coating film, so that sufficient hardness cannot be obtained, thereby resulting in insufficient migration resistance.

That is, among the solvents described above, a solvent having a hydroxyl group is preferable, and a solvent containing a secondary alcohol is more preferable. Examples of the secondary alcohol include 1-methoxy-2-propanol, 4-methyl-2-pentanol, 2-propanol, 2-butanol, propylene glycol n-propyl ether, and the like, of which 1-methoxy-2-propanol and propylene glycol n-propyl ether are preferable. Any one of these secondary alcohols may be used alone, or two or more thereof may be used in combination.

When a secondary alcohol is blended, it is preferable to blend only a secondary alcohol or to blend a secondary alcohol in combination with a solvent having a higher evaporation rate than the secondary alcohol to be blended (hereinafter also referred to as a quick-drying solvent).

The quick-drying solvent not only evaporates easily even at low temperatures and hence is expected to improve the drying performance of the coating film, but also evaporates faster than the secondary alcohol and hence can increase the concentration of secondary alcohol in the coating film, whereby the quick-drying solvent does not inhibit the secondary alcohol from being taken into the coating film through the urethane bonds.

Conversely, when a large amount of a solvent having a lower evaporation rate than the secondary alcohol is used, the secondary alcohol evaporates first, so that the secondary alcohol concentration in the coating film cannot be increased.

For example, when 1-methoxy-2-propanol is used as the secondary alcohol, it is preferable that 1-methoxy-2-propanol is used in combination with another solvent, such as n-butyl acetate, toluene, methyl ethyl ketone, ethyl acetate, etc., which has a higher evaporation rate than 1-methoxy-2-propanol.

When propylene glycol n-propyl ether is used as the secondary alcohol, it is preferable that propylene glycol n-propyl ether is used in combination with another solvent, such as n-butyl acetate, 5-methyl-2-hexanone, toluene, methyl ethyl ketone, ethyl acetate, etc., which has a higher evaporation rate than propylene glycol n-propyl ether.

Any one of these quick-drying solvents may be used alone, or two or more thereof may be used in combination.

The amount of the solvent used is not particularly limited, but is preferably 30% by mass or more and 600% by mass or less, more preferably 40% by mass or more and 400% by mass or less, and still more preferably 50 mass % or more and 300 mass % or less, with respect to the total mass of the polyol compound as the main agent.

When the amount of the solvent used is not less than the above lower limit value, the catalyst concentration in the polyurethane coating composition can be prevented from becoming excessive, so that the pot life is not affected. When the amount of the solvent used is not more than the above upper limit value, it is possible to suppress the residual solvent in the coating even when the curing of the coating is implemented with mild heat-drying conditions and shorter curing period, so that the coating film exhibits excellent migration resistance.

When the secondary alcohol described above is contained in the solvent, the amount of the secondary alcohol is preferably 40% by mass or more and 90% by mass or less, more preferably 50% by mass or more and 80% by mass or less, and still more preferably 60 mass % or more and 75 mass % or less, with respect to the total mass of the solvent.

When the secondary alcohol and the quick-drying solvent are used in combination, the mass ratio of the secondary alcohol to the quick-drying solvent (mass of secondary alcohol/mass of quick-drying solvent) is preferably 0.8 to 5.0, more preferably 1.0 to 3.0, and still more preferably 1.1 to 2.5.

When the solvent having a hydroxyl group described above is used as the solvent, the ratio of the polyol compound and the polyisocyanate compound which are contained in the polyurethane coating composition of the present embodiment is preferably such that the molar equivalent of the isocyanate group of the polyisocyanate compound per 1 molar equivalent of the hydroxyl group of the polyol compound (isocyanate group/hydroxyl group) is preferably 0.5 or more and 4.0 or less, more preferably such that the molar equivalent of the isocyanate group is 0.8 or more and 3.5 or less, still more preferably such that the molar equivalent of the isocyanate group is 1.1 or more and 3.0 or less, and particularly preferably such that the molar equivalent of the isocyanate group is 1.15 or more and 2.0 or less. When the isocyanate group of the polyisocyanate compound is excessive relative to the hydroxyl group of the polyol compound, the hydroxyl group in the solvent is more likely to react with the isocyanate group, whereby the solvent is incorporated into the coating film and the migration resistance of the coating improves.

### Optional Component

The polyurethane coating composition of the present embodiment may further contain, as necessary, an additive of such a type and in such an amount that the effects of the present invention are not impaired. Examples of the additive include dispersants, fluidity modifiers, ultraviolet absorbers, light stabilizers, surface modifiers, and the like. In order to improve the abrasion resistance of the coating film, a polyethylene wax may be blended.

Further, the polyurethane coating composition of the present embodiment may further contain a colorant such as a dye or a pigment (e.g., a coloring pigment, a luster material, an extender pigment, or other decorative pigments). The use of a colorant enables the coloring of the coating film or the adjustment of gloss or texture of the coating film. However, when a clear (colorless) coating is to be formed, the polyurethane coating composition is prepared without addition of a colorant.

### Method for Producing Polyurethane Coating Composition

The polyurethane coating composition of the present invention is usable as a two-pack paint. That is, it is preferable that the main agent containing the polyol compound and the curing agent containing the polyisocyanate compound are separately prepared in advance, and the main agent and the curing agent are mixed immediately before use. It is more preferable that the curing agent is added to a mixture of the main agent and the solvent to produce a polyurethane coating composition before use.

The quaternary ammonium salt catalyst composed of the tertiary amine compound and the weak acid in the present embodiment is preferably mixed into the main agent before being mixed with the curing agent.

### Method for Producing Coated Product

The polyurethane coating composition of the present embodiment can be used to implement a method for producing a coated product, which include forming a coating film on the surface of a product or a component part of a product. The use of the polyurethane coating composition of the present embodiment enables the curing of the coating film to be implemented with milder heat-drying conditions and shorter curing period, so that workability is greatly improved.

For example, a coated product with a short production cycle, which needs to be produced in a predetermined amount within a predetermined period, can be produced efficiently with high reliability. The product is not particularly limited, and examples thereof include parts of automobiles, household appliances, optical products, and amusement products. The coating film of the polyurethane coating composition can be obtained by applying the polyurethane coating composition prepared by the above-described method onto a surface of a product or a component part of a product, followed by drying and subsequent curing treatment.

Examples of the method for applying the polyurethane coating composition in the step of forming the coating film include known coating methods such as a roll coating method, a spray method, a dip method, and a brush coating method. The thickness of the coating film is preferably 1 to 100 μm. The thickness is more preferably 10 to 50 μm, and still more preferably 15 to 25 μm. When the thickness is less than 1 μm, it is difficult to manage the process of forming the coating film. When the thickness exceeds 100 μm, the workability is deteriorated, which is not economically preferable. That is, when the thickness of the coating film is 1 μm or more, it is easy to manage the process of forming the coating film, and when the thickness of the coating film is 100 μm or less, the workability is improved, which is economically favorable. A coating film having a desired thickness may be formed by one-time application, or the application may be repeated more than once so as to form a coating film having a desired thickness.

### EXAMPLES

Hereinbelow, the present invention will be described in more detail with reference to the Examples which, however, should not be construed as limiting the present invention.

The charged amounts (parts by mass) of the polyol compound, the catalyst, the solvent, and the surface modifier as an optional component are shown in Tables 2, 4, and 5. Each of the numerical values for the polyisocyanate compounds in Tables 2, 4, and 5 indicates the molar equivalent (isocyanate group/hydroxyl group) of the isocyanate group in the polyisocyanate compound per 1 molar equivalent of the hydroxyl group of the polyol compound, and the polyisocyanate compounds were used in respective amounts matching the numerical values.

The raw materials used in the Examples are as follows.

### Raw Materials Used

### Polyol Compound

As the polyol compounds, the following compounds were used.
Acrylic polyol dispersion including 61 to 63 mass % acrylic polyol and 37 to 39 mass % butyl acetate (trade name “ACRYDIC WAU-137-BA”, manufactured by DIC Corporation, weight average molecular weight: 15,000, hydroxyl value: 35 mgKOH/g, acid value: 2 to 6 mgKOH/g).

### Polyisocyanate Compound

As the polyisocyanate compound, the following compound was used.
Isocyanurate type polyisocyanate (trade name “Coronate HX”, manufactured by Tosoh Corporation).

### Catalyst

The following compounds were used as the catalyst.
Octylate of diazabicycloundecene (trade name “U-CAT SA102”, manufactured by San-Apro Ltd.).
Phenol salt of diazabicycloundecene (trade name “U-CAT SA1”, manufactured by San-Apro Ltd.).
Octylate of diazabicyclononene (trade name “U-CAT1102”, manufactured by San-Apro Ltd.).
Diazabicycloundecene (trade name “DBU”, manufactured by San-Apro Ltd.).
Dibutyltin dilaurate (trade name “Dibutyltin Didodecanoate”, manufactured by Pure Chemical Co., Ltd.).
Dibutyltin dilaurate was diluted to 1% by mass with ethyl acetate.

### Solvent

The following compounds were used as the solvent.
Butyl acetate (trade name “butyl acetate”, manufactured by Sankyo Chemical Co., Ltd.).
5-methyl-2-hexanone (trade name “Isoamyl Methyl Ketone”, manufactured by Tokyo Chemical Industry Co., Ltd.).
1-methoxy-2-propanol (trade name “PGM propylene glycol monomethyl ether”, manufactured by Daishin Chemical Co., Ltd.).

### Optional Component

As the optional components, the following compounds were used.
Pigment (carbon black) (trade name “Mitsubishi Carbon Black #2350”, manufactured by Mitsubishi Chemical Corporation).
Surface conditioner (trade name “BYK-333”, manufactured by BYK-Chemie Japan).

### Method for Producing Polyurethane Coating Composition and Forming Coating Film

The acrylic polyol dispersion containing a polyol compound as a main agent, a pigment, a catalyst, and a surface conditioner were mixed to prepare a main agent solution. Then, the main agent solution and the polyisocyanate compound as a curing agent were mixed. With respect to the amount of the curing agent used, as described above, the amount was one that had been adjusted so that the molar equivalent (isocyanate group/hydroxyl group) of the isocyanate group in the polyisocyanate compound per 1 molar equivalent of the hydroxyl group of the polyol compound matches the predetermined value. A solvent was further added to the resulting mixed solution as necessary to obtain a polyurethane coating composition.

The prepared polyurethane coating composition was applied to the surface of an ABS substrate using a spray gun (trade name “W-101”, manufactured by ANEST IWATA Corporation) so as to form a coating film having a thickness of about 20 μm in a dried state. Then, the coating film obtained was dried at 60° C. for 10 minutes and allowed to stand at 25° C. for 20 hours for curing, whereafter the resulting coating film was evaluated by the method described below.

### Examples 1 to 13, and Comparative Examples 1 to 3

Following the method as described above, polyurethane coating compositions of Examples 1 to 13 and Comparative Examples 1 to 3 were prepared with blending ratios in terms of the parts by mass or the molar equivalent (isocyanate group/hydroxyl group) shown in Tables 2, 4, and 5, and coating films were formed.

### Method for Evaluating Polyurethane Coating Composition or Coating Film

The polyurethane coating compositions or coating films obtained by the above method were evaluated by the following method.

### Appearance Evaluation

With respect to each of the polyurethane coating compositions of Examples 1 to 3 and Comparative Examples 1 to 2, the smoothness (levelness) of surface of the coating film formed on the surface of the substrate using the composition was visually evaluated. In the following evaluation criteria, coating films rated as “A” and “B” were regarded as having passed the test.

### Evaluation Criteria

A: Highly smooth and free of practical problem

B: Sufficiently smooth and free of practical problem

B: Insufficiently smooth and had practical problem

### IPA Rub Test

A flannel (trade name “Ryomen Nel” (double-raised flannel), manufactured by Shikisensha Co., Ltd.) cut into 2 cm×2 cm was placed on the coating film formed on the surface of the substrate using each of the polyurethane coating compositions of Examples 1 to 3 and Comparative Examples 1 to 2, and was impregnated with 0.5 ml of isopropyl alcohol (also referred to as “IPA”). The resulting flannel was reciprocated 10 times on the coating film while applying a load of 500 g/cm 2. In the following evaluation criteria, coating films rated as “A” were regarded as having passed the test.

### Evaluation Criteria

A: Flannel was not colored.

B: Flannel was colored.

With respect to the coating films formed on the substrate surfaces using the polyurethane coating compositions of Examples 1 to 3 and Comparative Examples 1 and 2, the results of the appearance evaluation and the IPA rub test are shown in Table 2. In Table 2, DBU is diazabicycloundecene, DBU-phenol salt is diazabicycloundecene phenol salt, DBU-octyl salt is diazabicycloundecene octylate, and DBN-octyl salt is diazabicyclononene octylate. BAC in Table 2 represents butyl acetate. The acrylic polyol in the table indicates an acrylic polyol compound as solids. A blank in the table indicates that no component was added. The same applies to Tables 4 and 5 below.

TABLE 2

| | | | | | Comp. | Comp. |
|---|---|---|---|---|---|---|
| | | Ex. 1 | Ex. 2 | Ex. 3 | Ex. 1 | Ex. 2 |
| Main agent | Acrylic polyol | 49.6 | 49.6 | 49.6 | 49.6 | 49.6 |
| Pigment | Carbon black | 4 | 4 | 4 | 4 | 4 |
| Catalyst | DBU-phenol salt | 0.5 | | | | |
| | DBU-octylate | | 0.5 | | | |
| | DBN-octylate | | | 0.5 | | |
| | DBU | | | | | 0.5 |
| Surface | BYK-333 | 0.2 | 0.2 | 0.2 | 0.2 | 0.2 |
| modifier | | | | | | |
| Curing | Equivalent ratio of | 1.08 | 1.08 | 1.08 | 1.08 | 1.08 |
| agent | polyisocyanate | | | | | |
| | compound | | | | | |
| | (NCO/OH) | | | | | |
| Solvent | BAC | 45.7 | 45.7 | 45.7 | 45.9 | 45.7 |
| | MIAK | | | | | |
| | PGM | 100 | 100 | 100 | 100 | 100 |

| | | | | | |
|---|---|---|---|---|---|
| Appearance | B | A | B | A | C |
| IPA rub test | A | A | A | B | A |

### Measurement of Pot Life

A viscosity cup (Iwata viscosity cup) was immersed in each of the polyurethane coating compositions of Example 10 and Comparative Example 1 so as to fill the inside of the viscosity cup with the polyurethane coating composition. Thereafter, the cup was pulled out from the polyurethane coating composition, immediately followed by starting time measurement with a stopwatch. The time (seconds) until the end of the flow of all the liquid in the viscosity cup was measured. The measurement samples of the polyurethane coating composition were taken immediately after preparation (0 minutes) and after having been stored for 60 minutes, 120 minutes, 180 minutes, 240 minutes, 300 minutes, and 360 minutes at storage temperatures described below. The storage temperatures were the following three different temperatures: 5° C., 25° C., and 40° C.

TABLE 3

| Time | | | | | | |
|---|---|---|---|---|---|---|
| lapsed | Example 10 | | | Comparative Example 1 | | |
| (min) | 5° C. | 25° C. | 40° C. | 5° C. | 25° C. | 40° C. |
| 0 | 8.88 | 8.20 | 8.02 | 8.91 | 8.12 | 7.99 |
| 60 | 9.04 | 8.28 | 8.02 | 9.04 | 8.23 | 8.06 |
| 120 | 9.08 | 8.24 | 8.08 | 9.02 | 8.22 | 8.06 |
| 180 | 9.08 | 8.27 | 8.21 | 9.06 | 8.22 | 8.16 |
| 240 | 9.09 | 8.29 | 8.34 | 9.06 | 8.27 | 8.26 |
| 300 | 9.09 | 8.32 | 8.39 | 9.04 | 8.33 | 8.32 |
| 360 | 9.10 | 8.38 | 8.50 | 9.08 | 8.39 | 8.43 |

Table 3 shows the results of pot life measurement of the polyurethane coating compositions of Example 10 and Comparative Example 1.

### Film Migration Evaluation

A polyolefin-based surface protective film (trade name “SPV-364 series 364MK”, manufactured by Nitto Denko Corporation) was attached to each of the coating films formed on the substrate surfaces using the polyurethane coating compositions of Examples 4 to 13 and Comparative Example 3, and the resulting was allowed to stand at 25° C. for 1 week. Then, the surface protective film was removed, and the exposed surface of the coating film was visually observed. In the following evaluation criteria, coating films rated as “A” to “D” were regarded as having passed the test.

### Evaluation Criteria

A: No change was observed on the surface.

B: Almost no change was observed on the surface.

C: A slight amount of remnant of the protective film was observed on the surface.

D: A remnant of the protective film was observed on the surface.

E: A large amount of remnant of the protective film was observed on the surface.

### Hardness Measurement

A pencil (trade name “HI-UNI”, manufactured by Mitsubishi Pencil Co., Ltd.) was held at an angle of about 45° with respect to each of the coating films formed on the substrate surfaces using the polyurethane coating compositions of Examples 4 to 13 and Comparative Example 3, and pressed against the coating film to such an extent that the pencil lead does not break. Then, the pencil was continuously moved at a uniform speed until the pressing was finished, and the hardness was evaluated based on the hardness of the lead (H, HB) of the pencil that had left a clearly visible scratch.

With respect to the coating films formed on the substrate surfaces using the polyurethane coating compositions of Examples 4 to 13 and Comparative Example 3, the results of the film migration evaluation and the hardness measurement are shown in Tables 4 and 5. In Tables 4 and 5, DBTDL represents a 1% by mass dibutyltin dilaurate solution (diluting solvent: ethyl acetate), MIAK represents 5-methyl-2-hexanone, and PGM represents 1-methoxy-2-propanol.

TABLE 4

| | | | | | | Comp. |
|---|---|---|---|---|---|---|
| | | Ex. 4 | Ex. 5 | Ex. 6 | Ex. 7 | Ex. 3 |
| Main agent | Acrylic polyol | 49.6 | 49.6 | 49.6 | 49.6 | 49.6 |
| Pigment | Carbon black | 4 | 4 | 4 | 4 | 4 |
| Catalyst | DBU-octylate | 0.5 | 1.0 | 2.0 | 4.0 | 0 |
| | DBTDL | | | | | |
| Surface | BYK-333 | 0.2 | 0.2 | 0.2 | 0.2 | 0.2 |
| modifier | | | | | | |
| Curing | Equivalent ratio of | 1.08 | 1.08 | 1.08 | 1.08 | 1.08 |
| agent | polyisocyanate | | | | | |
| | compound | | | | | |
| | (NCO/OH) | | | | | |
| Solvent | BAC | 129.9 | 129.9 | 129.9 | 129.9 | 129.9 |
| | MIAK | 20 | 20 | 20 | 20 | 20 |
| | PGM | | | | | |

| | | | | | |
|---|---|---|---|---|---|
| Film migration | C | C | D | D | E |
| Hardness | HB | HB | B | B | B |

TABLE 5

| | | Ex. 8 | Ex. 9 | Ex. 10 | Ex. 11 | Ex. 12 | Ex. 13 |
|---|---|---|---|---|---|---|---|
| Main | Acrylic polyol | 49.6 | 49.6 | 49.6 | 49.6 | 49.6 | 49.6 |
| agent | | | | | | | |
| Pigment | Carbon black | 4 | 4 | 4 | 4 | 4 | 4 |
| Catalyst | DBU-octylate | 0.5 | 1.0 | 0.5 | 0.5 | 0.5 | 1.0 |
| | DBTDL | | | | 0.5 | | |
| Surface | BYK-333 | 0.2 | 0.2 | 0.2 | 0.2 | 0.2 | 0.2 |
| modifier | | | | | | | |
| Curing | Equivalent ratio of | 1.08 | 1.08 | 1.08 | 1.08 | 1.20 | 1.20 |
| agent | polyisocyanate | | | | | | |
| | compound | | | | | | |
| | (NCO/OH) | | | | | | |
| Solvent | BAC | 144.7 | 144.4 | 44.7 | 44.5 | 44.7 | 44.5 |
| | MIAK | | | | | | |
| | PGM | | | 100 | 100 | 100 | 100 |

| | | | | | | |
|---|---|---|---|---|---|---|
| Film migration | C | D | B | B | A | A |
| Hardness | HB | HB | HB | HB | HB | HB |

As shown in Table 2, Examples 1 to 3 using the quaternary ammonium salt composed of a tertiary amine compound and a weak acid as a catalyst showed favorable results in both of the appearance evaluation and the IPA rub test, and enabled curing with milder heat-drying conditions and shorter curing period. On the other hand, in Comparative Example 1 without using a catalyst, the unreacted polyol was dissolved in isopropyl alcohol, resulting in the rating “B” in the IPA rub test. Thus, it was found that curing was insufficient under the conditions of Comparative Example 1. In Comparative Example 2 using diazabicycloundecene as a catalyst, the activity was too high, so that the curing reaction proceeded immediately after coating, and the polyurethane coating composition did not spread well. As a result, only a coating film with low smoothness was obtained.

As shown in Table 3, the pot life in Example 10 using the quaternary ammonium salt composed of a tertiary amine compound and a weak acid as a catalyst was equivalent to that in Comparative Example 1 without using a catalyst, which revealed that the addition of catalyst does not affect the pot life.

From the results of Examples 4 to 7 shown in Table 4, it was confirmed that the increase in the addition amount of the catalyst resulted in inferior hardness and film migration. This was considered to be due to the residual liquid catalyst in the coating film.

From the results of Examples 10 to 13 shown in Table 5, it was confirmed that the use of a secondary alcohol as a solvent improved the hardness and the film migration. It was also confirmed that when the molar equivalent of the isocyanate group in the polyisocyanate compound per 1 molar equivalent of hydroxyl group in the polyol compound was increased, the film migration was improved. This was assumed to be because the hydroxyl group in the secondary alcohol reacted with the isocyanate group in the polyisocyanate compound and was incorporated into the coating film.

### INDUSTRIAL APPLICABILITY

The polyurethane coating composition of the present invention can be widely used as a polyurethane coating composition including a highly reactive catalyst that allows for milder heat-drying conditions for curing of a coating film and reduction of curing time without affecting the pot life. The composition can also be widely used as a polyurethane coating composition including a catalyst that can replace organotin catalysts which are restricted to be used in a limited amount due to toxicity problems, environmental problems, and REACH regulations. Further, the polyurethane coating composition can be used for producing a coated product by a process of forming a coating film and, therefore, is industrially applicable.

1. A polyurethane coating composition comprising: a polyol compound as a main agent; a polyisocyanate compound as a curing agent; a quaternary ammonium salt comprising a tertiary amine compound and a weak acid; and a solvent, wherein the solvent comprises a secondary alcohol.

2. The polyurethane coating composition according to claim 1, wherein the tertiary amine compound is an amidine compound.

3. The polyurethane coating composition according to claim 1, wherein the tertiary amine compound is diazabicyclononene or diazabicycloundecene.

4. The polyurethane coating composition according to claim 1, wherein the amount of the quaternary ammonium salt is 2.5% by mass or less based on the total mass of the polyol compound as the main agent.

5. The polyurethane coating composition according to claim 1, wherein the weak acid is an aliphatic carboxylic acid or an aromatic compound having a phenolic hydroxyl group.

6. The polyurethane coating composition according to claim 1, wherein the weak acid is phenol or octanoic acid.

7. The polyurethane coating composition according to claim 1, wherein the polyol compound is at least one polyol compound selected from the group consisting of an acrylic polyol, a polycarbonate polyol, and a polyether polyol.

8. The polyurethane coating composition according to claim 1, wherein the polyol compound is an acrylic polyol.

9. (canceled)

10. (canceled)

11. The polyurethane coating composition according to claim 1, wherein the solvent further comprises a solvent having a higher evaporation rate than the secondary alcohol.

12. The polyurethane coating composition according to claim 1, wherein an equivalent ratio of a hydroxyl group in the polyol compound and an isocyanate group in the polyisocyanate compound (isocyanate group/hydroxyl group) is 1.1 or more and 3.0 or less.

13. A method for producing a coated product, comprising forming a coating film on a surface of a product or a component part of a product using the polyurethane coating composition of claim 1.
